(19) United States
(12) Patent Application Publication
(10) Pub. No.: US 2022/0314258 A1
(43) Pub. Date: Oct. 6, 2022

(54) ANTI RUN-OVER SPRINKLER DEVICE

(71) Applicant: Joaquin Garza Muguerza, San Antonio, TX (US)

(72) Inventor: Joaquin Garza Muguerza, San Antonio, TX (US)

(21) Appl. No.: 17/216,682

(22) Filed: Mar. 30, 2021

(51) Int. Cl. B05B 15/622; B05B 15/70

(52) U.S. Cl. CPC B05B 15/622; B05B 15/70

(57) ABSTRACT

An anti run-over (ARO) sprinkler device including a housing, piston region, body region, piston, first cap, first seal, primary spring, second cap, second seal, secondary spring and water inlet. The device operates to prevent damage to the device when unintentional force is applied thereto. The device includes a secondary spring which contracts when unintentional force is applied to the device to prevent damage to the device. The secondary spring is configured to operate in either a contracted state where coils of the secondary spring are compressed together thereby causing the piston to pull downwards into the second cavity of the housing when pressure is applied to the second cavity or in a retracted state where the coils of the secondary spring are extended away from one another thereby causing the piston to push outward from the second cavity and into the first cavity when the pressure applied to the second cavity ceases.

### FIELD OF THE INVENTION

Embodiments described herein generally relate to a sprinkler device, and more particularly to an anti run-over sprinkler device.

### BACKGROUND OF THE INVENTION

Sprinklers have the tendency to easily get damaged when a person kicks it with their feet or when it gets run over by a vehicle. Further, a person at times does not have control of how or when their sprinkler systems gets destroyed. As a result of the weak tubing parts, constant changing of the sprinkler device may be necessary and costly. Hence, an improved sprinkler that provides an individual with flexible tubing that is sustainable to damage of any kind is desirable.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of an anti-run over sprinkler device according to an embodiment of the present disclosure.

### SUMMARY OF THE INVENTION

Exemplary embodiments disclosed herein describe an anti run-over (ARO) sprinkler device including a housing, piston region, body region, piston, first cap, first seal, primary spring, second cap, second seal, secondary spring and water inlet. The housing including a primary housing and a secondary housing. The primary housing including a first cavity for enclosing a piston and a primary spring and the secondary housing including a second cavity for storing a secondary spring and a water inlet. The piston includes a nozzle and a riser stem, wherein the nozzle is attached to a proximate end of the riser stem. The first cap is attached to a proximate end of the primary housing, the first cap enclosing a first seal which is configured to prevent water from leaking from the proximate end of the primary housing. The primary spring encloses the riser stem and is configured to actuate vertical motion of the piston within the first cavity of the housing, the primary spring is configured to operate in either a contracted state where a plurality of coils of the primary spring are compressed together thereby causing the piston to move in an upward direction through the first cavity when pressure is applied to the first cavity or a retracted state where the plurality of coils of the primary spring are extended away from one another thereby causing the piston to move in a downward direction back into the first cavity when the pressure applied to the first cavity ceases. The second cap is attached to a proximate end of the secondary housing, the second cap enclosing a second seal which is configured to prevent water from leaking from the proximate end of the secondary housing. The secondary spring is enclosed within the secondary housing below the first cavity, the secondary spring is configured to operate in either a contracted state where a plurality of coils of the secondary spring are compressed together thereby causing the piston to move in a downward direction into the second cavity of the secondary housing when pressure is applied to the second cavity or in a retracted state where the plurality of coils of the secondary spring are extended away from one another thereby causing the piston to move in an upward direction back into the first cavity when the pressure applied to the second cavity ceases.

In some embodiments, the primary housing is located within a piston region of the device.

In some embodiments, the secondary housing is located within a body region of the device.

In some embodiments, the primary housing and the secondary housing share an overlapping region within the piston region and the body region.

In some exemplary embodiments, the pressure is applied to the first cavity when water passes through the water inlet.

In some exemplary embodiments, the pressure is applied to the second cavity when a force is applied to the nozzle while the primary spring is in a retracted state.

In some exemplary embodiments, a force is applied to the nozzle when the nozzle is stepped on or run over.

In some exemplary embodiments, the first seal includes an aperture for receiving the piston therethrough.

In some exemplary embodiments, the second seal includes an aperture for enclosing a portion of the secondary housing.

In some exemplary embodiments, the primary spring is a cylindrical retraction spring.

In some exemplary embodiments, the secondary spring is a cylindrical retraction spring.

In some exemplary embodiments, the default state of the primary spring is a retracted state.

In some exemplary embodiments, the default state of the secondary spring is a retracted state.

In some exemplary embodiments, the second cap is attached to the proximate end of the secondary housing where the first and second cavity abut one another.

### DETAILED DESCRIPTION

The present disclosure relates to an anti-runover sprinkler device (“the device”). The device is predominantly concealed in the ground and includes mechanical parts that rise (i.e., pop up) from the ground due to the pressure of a water source. When the device is predominantly concealed, someone or something (e.g., a car) may run over/step on the unconcealed part of the device which could cause severe damage to the device. The device includes an enclosure (i.e., a second cavity) at its lower region having a spring (i.e., secondary cylindrical spring) inside which prevents damage to the device when the device is stepped on or run over. The spring allows the structure of the device in the first cavity to move downward into the second cavity when the device is stepped on or run over.

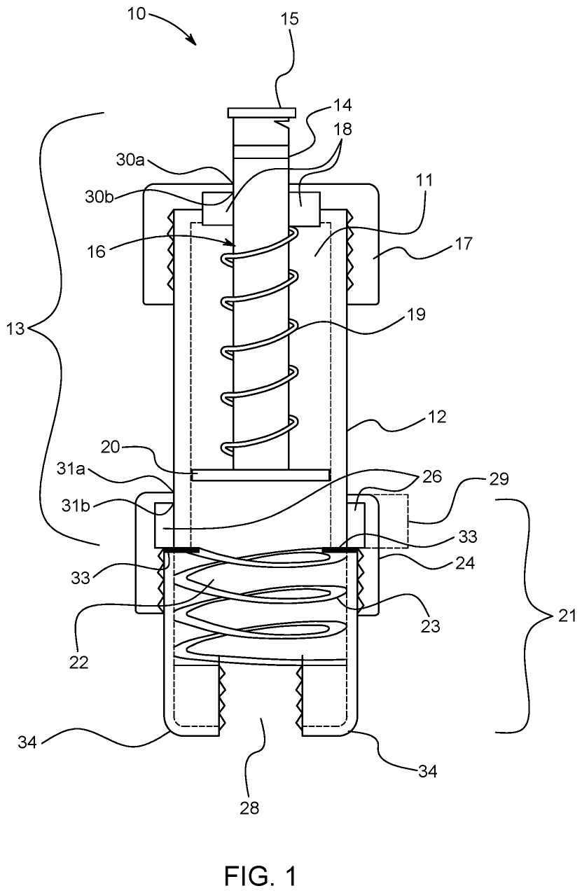

As illustrated in FIG. 1, the device 10 includes a housing (12 and 34), a first cavity 11, riser stem 14, a piston 16, a first cap 17, a first seal 18, a primary spring 19, a piston stopper 20, primary housing stopper(s) 33, a second cavity 22, a secondary spring 23, a second cap 24, a second seal 26 and a water inlet 28. The housing includes a primary housing 12 and a secondary housing 34. The device 10 includes a piston region 13, and a body region 21. The piston region 13 includes primary housing 12, piston 16, a first cavity 11 for enclosing piston 16, a first seal 18, primary spring 19 and piston stopper 20. The first cavity 11, piston 16, primary spring 19, and piston stopper 20 are enclosed in primary housing 12. The body region 21 includes secondary housing 34, secondary spring 23, second cavity 22 for storing secondary spring 23, water inlet 28, second cap 24, second seal 26 and primary housing stopper 33. The second cavity 22, secondary spring 23 and water inlet 28 are enclosed within secondary housing 34. The piston region 13 and the body region 21 share an overlapping region 29. The primary housing 12 and the secondary housing 34 may be constructed of any suitable material, such as, for example, plastic.

The piston 16 includes a nozzle 15, a riser stem 14 and a piston stopper 20. The nozzle includes one or more openings for releasing water and is attached to a proximate end of the riser stem. The riser stem 14 moves up and down in the first cavity 11 to raise the nozzle above the surrounding grass blades or crops for watering and to lower the nozzle when watering stops. The piston stopper 20 prevents the riser stem 14 from being pushed out of primary housing 12. The piston lifts up from the first cavity 11 when the device is operating (i.e., activated to release water from the nozzle) and then retracts back below ground when not in use.

The first cap 17 is attached to a proximate end of the primary housing 12 and is configured to secure the nozzle 15 to the riser stem 14. The first cap 17 encloses first seal 18. The first seal may be made of plastic and is configured to seal the riser stem 14 so that water leakage does not occur at the proximate end of the primary housing 12 (i.e., where the first cap attaches to the housing). The first cap 17 and the first seal 18 both include an aperture (30a, 30b, respectively) through which the piston (i.e., riser stem 14) moves upwards and downwards.

The primary spring 19 is configured to actuate vertical motion of the piston within the first cavity 11 of the housing 12. The primary spring may include a cylindrical retraction spring which includes a plurality of coils that are configured to operate in either a retracted state (i.e., the default state of the plurality of coils) or a contracted state. In a contracted state, the plurality of coils are compressed together. In a retracted state, the plurality of coils are extended away from one another. The riser stem 14 may be enclosed within the plurality of coils of the primary spring. The primary spring may be activated automatically when force is applied to the first cavity 11. The force applied to the first cavity 11 may be exerted from water pressure which is applied to the first cavity when water enters water inlet 28 and travels upstream through the first cavity 11.

In operation, the device 10 may be installed in the ground of a lawn, garden, agricultural crop region, landscape, golf course, and other areas. The housing (12 and 34) is installed underground in a vertical position such that the water inlet 28, which is located at the bottom of the device 10, connects to an underground water pipe and such that the first cap 17, which is located at the top of the device 10, is positioned at ground level (i.e., soil level). When water passes through the water inlet 28 from the water pipe, pressure is applied to first cavity 11.

The applied pressure causes the primary spring 19 to contract thereby causing the piston (i.e., the riser stem 14 part of the piston), to move in an upward direction through the aperture in the first seal 18 and first cap 17 such that the nozzle 15 rises above any surrounding grass blades, crops, etc. Then, water is continuously released from the nozzle onto the surrounding grass blades or crops so long as water is received through the water inlet 28. When the water stops passing through the first cavity, the water pressure applied to the first cavity ceases which causes the plurality of coils to retract. The retraction of the plurality of coils causes the piston (i.e., the riser stem 14 part of the piston) to move in a downward direction back into the first cavity 11.

The second cap 24 is attached to a proximate end of the secondary housing 34 where the first cavity 11 and the second cavity 22 abut one another. The second cap is configured to secure the piston region 13 to the body region 21. The second cap 24 encloses second seal 26. The second seal may be made of plastic and is configured to seal the portion of the piston region which extends into the body region 21 (i.e., overlapping region 29) so that water leakage does not occur at the proximate end of the secondary housing 34 (i.e., where the second cap attaches to the secondary housing). Since, the second cavity 22 is wider than the first cavity 11, water may be prone to leak where the first cavity abuts the second cavity; thus, the second seal operates to prevent water leakage in that area. The second cap 24 and the second seal 26 both include an aperture (31a, 31b, respectively) for enclosing the portion (i.e., region 29) of the piston region which extends into the body region 21, and through which the piston (i.e., riser stem 14 and piston stopper 20) moves upwards and downwards.

The secondary spring 23 is enclosed within the secondary housing 34 directly below the first cavity 11. The secondary spring is configured to actuate vertical motion of primary housing 12 within the second cavity 22 of the secondary housing 34. The secondary spring may include a cylindrical retraction spring which includes a plurality of coils that are configured to operate in either a retracted state (i.e., the default state of the plurality of coils) or a contracted state. In a contracted state, the plurality of coils are compressed together. In a retracted state, the plurality of coils are extended away from one another.

The secondary spring 23 may be activated automatically when force is applied to the second cavity 22. The force applied to the second cavity 22 may be exerted from pressure applied to nozzle 15 and/or first cap 17 while the primary spring is in a retracted state (which occurs when the device 10 is not releasing water from the nozzle 15). Pressure may be applied to the nozzle 15 and/or first cap 17 when, for example, an entity (e.g., an individual, an animal, etc.) steps on the nozzle. Moreover, pressure may be applied to the nozzle and/or first cap 17 when, for example, an automobile, lawn mower, bike or any other moving device with wheels runs over the nozzle and/or first cap 17.

When force is applied to the second cavity 22, the plurality of coils of the secondary spring 23 contract, thereby causing the primary housing 12 to move in a downward direction into the second cavity 22. When the force applied to the second cavity ceases, the plurality of coils of the secondary spring retract, thereby causing the primary housing 12 to move in an upward direction back into the first cavity 11. Moreover, when pressure is applied to nozzle 15 and/or first cap 17 while the primary spring 19 is in a retracted state, the pressure may cause the primary housing 12 (i.e., the wall structure of the primary housing) to move downwards into the second cavity 22. The primary housing stopper(s) 33 effectively close the space needed to allow for the passage of the primary housing, thereby preventing the primary housing structure from moving into the body region 21 (i.e., the region of body 21 that does not overlap with piston region 13).

Moreover, it should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. An anti run-over (ARO) sprinkler device comprising:
a housing including a primary housing and a secondary housing, the primary housing including a first cavity for enclosing a piston and a primary spring and the secondary housing including a second cavity for storing a secondary spring and a water inlet;
the piston including a nozzle and a riser stem, wherein the nozzle is attached to a proximate end of the riser stem;
a first cap attached to a proximate end of the primary housing, the first cap enclosing a first seal which is configured to prevent water from leaking from the proximate end of the primary housing;
the primary spring encloses the riser stem and is configured to actuate vertical motion of the piston within the first cavity of the primary housing, the primary spring is configured to operate in either a contracted state where a plurality of coils of the primary spring are compressed together thereby causing the piston to move in an upward direction through the first cavity when pressure is applied to the first cavity or a retracted state where the plurality of coils of the primary spring are extended away from one another thereby causing the piston to move in a downward direction back into the first cavity when the pressure applied to the first cavity ceases;
a second cap attached to a proximate end of the secondary housing, the second cap enclosing a second seal which is configured to prevent water from leaking from the proximate end of the secondary housing; and
the secondary spring is enclosed within the secondary housing below the first cavity, the secondary spring is configured to operate in either a contracted state where a plurality of coils of the secondary spring are compressed together thereby causing the primary housing to move in a downward direction into the second cavity of the secondary housing when pressure is applied to the second cavity or in a retracted state where the plurality of coils of the secondary spring are extended away from one another thereby causing the primary housing to move in an upward direction back into the first cavity when the pressure applied to the second cavity ceases.

2. The device of claim 2, wherein the primary housing is located within a piston region of the device.

3. The device of claim 2, wherein the secondary housing is located within a body region of the device.

4. The device of claim 3, wherein the primary housing and the secondary housing share an overlapping region within the piston region and the body region.

5. The device of claim 1, wherein pressure is applied to the first cavity when water passes through the water inlet.

6. The device of claim 5, wherein pressure is applied to the second cavity when a force is applied to the nozzle and/or first cap while the primary spring is in a retracted state.

7. The device of claim 6, wherein a force is applied to the nozzle and/or first cap when the nozzle and/or first cap are/is stepped on or run over.

8. The device of claim 1, wherein the first seal includes an aperture for receiving the piston therethrough.

9. The device of claim 3, wherein the second seal includes an aperture for enclosing a portion of the secondary housing.

10. The device of claim 1, wherein the primary spring is a cylindrical retraction spring.

11. The device of claim 1, wherein the secondary spring is a cylindrical retractable spring.

12. The device of claim 1, wherein a default state of the primary spring is a retracted state.

13. The device of claim 1, wherein a default state of the secondary spring is a retracted state.

14. The device of claim 1, wherein the second cap is attached to a proximate end of the secondary housing where the first and second cavity abut one another.
